(19) United States
(12) Patent Application Publication
(10) Pub. No.: US 2026/0193894 A1
(43) Pub. Date: Jul. 9, 2026

(54) CEMENTITIOUS PRODUCT COMPRISING A BRANCHED CHANNEL

(71) Applicant: MIMICRETE LTD, Cambridge Cambridgeshire (GB)

(72) Inventor: Zijing Li, Cambridge Cambridgeshire (GB)

(21) Appl. No.: 19/132,576

(22) PCT Filed: Nov. 24, 2023
(86) PCT No.: PCT/GB2023/053063

§ 371 Date: May 23, 2025

(30) Foreign Application Priority Data
Nov. 25, 2022 (GB) 2217723.2

(51) Int. Cl. E04G 23/02; C04B 16/12; C04B 28/04; C04B 111/72

(52) U.S. Cl. CPC E04G 23/0203; C04B 16/12; C04B 28/04; C04B 2111/72

(57) ABSTRACT

A cementitious product (1) comprising: a substrate (2) formed from a cementitious material; and at least one branched channel (3) embedded within the substrate configured to provide a conduit for a second material to flow through the substrate; wherein the at least one branched channel comprises a plurality of interconnected channel elements, the plurality of interconnected channel elements comprising at least one diverging portion at which a plurality of paths diverge from a common path, and/or at least one converging portion at which a plurality of paths converge to a common path.

### TECHNICAL FIELD

The present disclosure relates to a cementitious product.

### BACKGROUND ART

Cementitious materials such as concrete are durable and long-lasting. They are widely used for modern civil construction. However, the formation of cracks (cracking) is inevitable. Large cracks may compromise structural integrity of a cementitious product in the short term and small cracks may grow into large cracks over time. Cracks may also provide paths for undesirable fluid ingress, such as water, petroleum, toxic materials and radioactive leaching to unexpected areas, causing structural, health, economic and ecological problems.

Vascular systems for healing cracks in concrete by using channels within the product to fill cracks with a healing agent are known from academic literature. However, these vascular systems are not easily scalable from the lab, do not generally provide adequate coverage throughout the product, unable to be adjusted to other suitable applications according to industrial operational requirements, and/or are difficult to construct.

The present disclosure aims to at least partially solve the above problems.

### SUMMARY OF THE INVENTION

According to an aspect of the disclosure there is provided a cementitious product comprising: a substrate formed from a cementitious material; and at least one branched channel embedded within the substrate configured to provide a conduit for a second material to flow through the substrate; wherein the at least one branched channel comprises a plurality of interconnected channel elements, the plurality of interconnected channel elements comprising at least one diverging portion at which a plurality of paths diverge from a common path, and/or at least one converging portion at which a plurality of paths converge to a common path.

Optionally, the channel elements are formed separately and configured to be connected during assembly of the branched channel.

Optionally, the plurality of channel elements comprise at least one branching channel element comprising m input/output portions connected to n further input/output portions, where m>0 and m<n, the plurality of interconnected channel elements being configured to be connected via the input/output portions. Optionally, the branching channel element comprises only diverging portions or only converging portions. Optionally, the branching channel element comprises only one diverging portion or only one converging portion.

Optionally, the branching channel element comprises both diverging and converging portions.

Optionally, at least two diverging portions are connected at a converging portion or at least two converging portions are connected at a diverging portion.

Optionally, the plurality of channel elements comprise at least one joining channel element comprising p input/output paths connected to p further input/output portions, where p>0, the plurality of interconnected channel elements being configured to be connected via the input/output portions.

Optionally, at least one joining channel element is a linear joining channel element comprising only a single path between one input/output portion and one further input/output portion.

Optionally, at least one joining channel element is a branching joining channel element comprising at least one diverging portion and at least one converging portion. Optionally, the branching joining channel element comprises the same number of converging portions as diverging portions.

Optionally, the branching joining channel element comprises at least one branching cell comprising one diverging portion and one converging portion having the same number of paths, said paths being respectively directly connected to each other. Optionally, the branching joining channel element comprises multiple branching cells arranged in series.

Optionally, the branching joining channel element comprises an unequal number of diverging portions and converging portions.

Optionally, the branching joining channel element comprises a plurality of single paths comprising one input/output portion connected to one further input/output portion, said single paths connected to each other by at least one linking path.

Optionally, the channel elements are repeatable units selected from a finite number of different types of channel elements, formed separately and configured to be connected via input/output portions during assembly of the branched channel. Optionally, the branched channel comprises at least one of each of the following types of channel element: a branching channel element comprising m input/output portions connected to n further input/output portions, where m>0 and m<n, and only one diverging portion or only one converging portion; a branching channel element comprising m input/output portions connected to n further input/output portions, where m>1 and m<n, and at least two diverging portions are connected at a converging portion or at least two converging portions are connected at a diverging portion; a branched joining channel element comprising p input/output portion connected to p further input/output portion, where p>0, and at least one branching cell comprising one diverging portion and one converging portion having the same number of paths, said paths being respectively directly connected to each other; a branched joining channel element comprising p input/output portion connected to p further input/output portion, where p>1, and comprising p single paths comprising one input/output portion connected to one further input/output portion, said single paths connected to each other by at least one linking path. Optionally, the branched channel comprises at least one type of channel element that is a branched joining channel element comprising one input/output portion connected to one further input/output portion, and multiple branching cells arranged in series, each branching cell comprising one diverging portion and one converging portion having the same number of paths, said paths being respectively directly connected to each other.

Optionally, the plurality of interconnected channel elements extend substantially in two orthogonal directions.

Optionally, the plurality of interconnected channel elements extend substantially in three orthogonal directions.

Optionally, the channel elements are formed from a polymer material. Optionally, the channel elements are formed from a PLA.

Optionally, the cementitious product comprises the second material within the at least one branched channel.

Optionally, the second material comprises gap filling material configured to fill gaps in the cementitious product.

According to a second aspect of the disclosure, there is provided a branched channel for use in a cementitious product, e.g. the cementitious product of any preceding aspect, comprising: a plurality of interconnected channel elements, the plurality of interconnected channel elements comprising at least one diverging portion at which a plurality of paths diverge from a common path, and/or at least one converging portion at which a plurality of paths converge to a common path; the branched channel being configured to be embedded within the substrate formed from a cementitious material, and to provide a conduit for a fluid material to flow through the substrate.

According to a third aspect of the disclosure, there is provided a kit of parts for forming a branched channel, e.g. the branched channel of the second aspect, comprising: a plurality of channel elements, the plurality of channel elements comprising at least one diverging portion at which a plurality of paths diverge from a common path, and/or at least one converging portion at which a plurality of paths converge to a common path; the plurality of channel elements being configured to be interconnected to form a branched channel configured to be embedded within the substrate formed from a cementitious material and to provide a conduit for a fluid material to flow through the substrate.

Optionally, the channel elements are repeatable units selected from a finite number of different types of channel elements, formed separately and configured to be connected via input/output portions during assembly of the branched channel. Optionally, the kit of parts comprises at least one of each of the following types of channel element: a branching channel element comprising m input/output portions connected to n further input/output portions, where m>0 and m<n, and only one diverging portion or only one converging portion; a branching channel element comprising m input/output portions connected to n further input/output portions, where m>1 and m<n, and at least two diverging portions are connected at a converging portion or at least two converging portions are connected at a diverging portion; a branched joining channel element comprising p input/output portion connected to p further input/output portion, where p>0, and at least one branching cell comprising one diverging portion and one converging portion having the same number of paths, said paths being respectively directly connected to each other; a branched joining channel element comprising p input/output portion connected to p further input/output portion, where p>1, and comprising p single paths comprising one input/output portion connected to one further input/output portion, said single paths connected to each other by at least one linking path. Optionally, the kit of parts comprises at least one type of channel element that is a branched joining channel element comprising one input/output portion connected to one further input/output portion, and multiple branching cells arranged in series, each branching cell comprising one diverging portion and one converging portion having the same number of paths, said paths being respectively directly connected to each other.

According to a fourth aspect of the disclosure, there is provided a branched channel formed from the kit of parts of the third aspect, the branched channel configured to be embedded within a substrate formed from a cementitious material and to provide a conduit for a fluid material to flow through the substrate.

According to a fifth aspect of the disclosure, there is provided a cementitious product comprising the branched channel of the fourth aspect formed from the kit of parts of the third aspect, embedded within the substrate formed from a cementitious material, and configured to provide a conduit for the fluid material to flow through the substrate.

According to a sixth aspect of the disclosure, there is provided a channel element for use in a cementitious product, e.g. the cementitious product of any preceding aspect, comprising: at least one diverging portion at which a plurality of paths diverge from a common path, and/or at least one converging portion at which a plurality of paths converge to a common path, the channel element being configured to be interconnected with at least one other channel element to form a branched channel configured to be embedded within the substrate formed from a cementitious material and to provide a conduit for a fluid material to flow through the substrate

According to a seventh aspect, there is provided a method of forming a cementitious product comprising: forming at least one branched channel configured to provide a conduit for a second material to flow through the substrate; and forming a substrate from a cementitious material around the least one branched channel, to embed the at least one branched channel within the substrate; wherein the at least one branched channel comprises a plurality of interconnected channel elements, the plurality of interconnected channel elements comprising at least one diverging portion at which a plurality of paths diverge from a common path, and/or at least one converging portion at which a plurality of paths converge to a common path.

According to an eighth aspect, there is provided a method of healing the cementitious product of the first aspect, comprising flowing the second material through the at least one branching channel.

According to a ninth aspect, there is provided a method of preventing corrosion of the cementitious product of the first aspect, comprising flowing the second material through the at least one branching channel.

According to an tenth aspect there is provided a method of forming a branched channel for use a cementitious product, e.g. in the cementitious product of any preceding aspect, comprising: forming a plurality of channel elements, the plurality of channel elements comprising at least one diverging portion at which a plurality of paths diverge from a common path, and/or at least one converging portion at which a plurality of paths converge to a common path; the plurality of channel elements being configured to be interconnected to form a branching channel configured to be embedded within the substrate formed from a cementitious material and to provide a conduit for a fluid material to flow through the substrate; connecting the plurality of channel elements together to from the branched channel.

In any of the above aspects, optionally, the channel elements comprise respective male and female engaging parts configured to connect adjacent channel elements. Optionally, the male and female engaging parts are bonded together. Optionally, the bonding is performed by heat welding or solvent welding.

### BRIEF DESCRIPTION OF THE DRAWINGS

Further features of the disclosure will be described below, by way of non-limiting examples and with reference to the accompanying drawings, in which:

FIG. 1 shows an example cementitious product with the vascular system;

FIG. 2 shows an example branched channel and delivery channel;

FIG. 3 shows an example branched channel without optional cells;

FIG. 4 shows an example channel element of a first type;

FIG. 5 shows an example channel element of a second type;

FIG. 6 shows an example channel element of a third type;

FIG. 7 shows an example channel element of a fourth type;

FIG. 8 shows a further example branched channel with optional cells installed;

FIG. 9 shows an example channel element of a fifth type;

FIG. 10 shows an example channel element of a sixth type;

FIG. 11 shows a further example branched channel; and

FIG. 12 shows a further example branched channel with different parameter settings;

FIG. 13 shows an example male connecting part;

FIG. 14 shows an example female connecting part;

FIG. 15 shows an example channel element of a seventh type.

### DETAILED DESCRIPTION

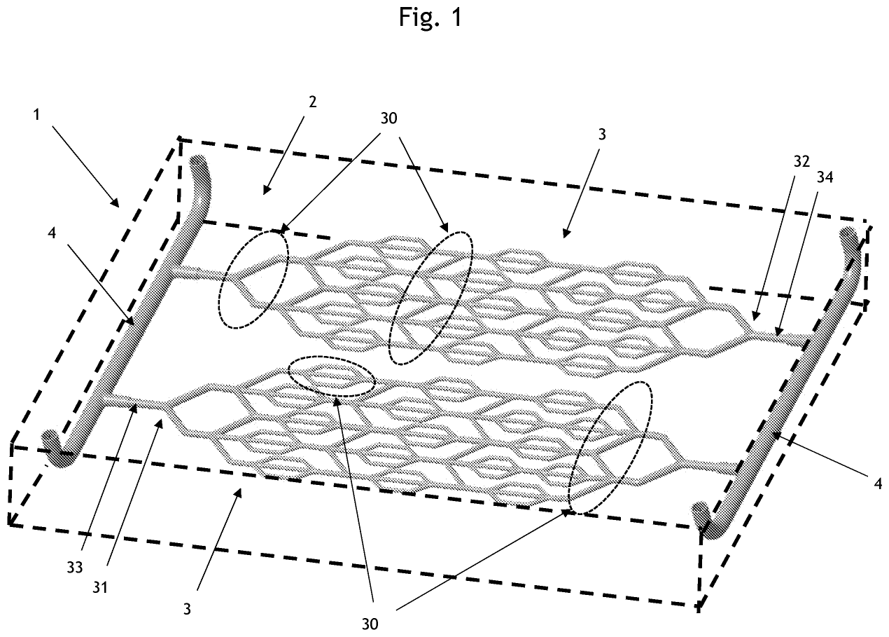

FIG. 1 shows an example cementitious product 1 according to the disclosure. The cementitious product comprises a substrate 2 formed from a cementitious material. The substrate 2 fills the region within the dashed lines of FIG. 1, but is shown transparently in FIG. 1 so that branched channels 3 are visible. As shown, the cementitious product 1 also comprises at least one branched channel 3 embedded within the substrate 2, e.g. two branched channels 3 as shown.

The cementitious material forming the substrate may comprise at least Portland cement or other types of cement (i.e. low-carbon cement) and water. Additional additive materials may be used, such as sand and/or aggregates. The cementitious material may be concrete, for example. The cementitious product 1 may be suitable for use in civil construction. A cementitious mixture comprising cement and water may be poured into moulds and set to form the substrate 2.

The branched channels 3 are configured to provide a conduit for a second material to flow through the substrate 2. The second material may be a healing agent, for example. The formation of cracks (cracking) in a cementitious product 1 is almost inevitable as described above. The second material may be a crack filling material configured to fill cracks in the cementitious product 1. The second material may be an inhibitor agent, for example. The inhibitor agent may mitigate the risk of toxic ions/cations in cementitious materials, for example. The inhibitor agent may prevent corrosion of the cementitious product, for example. When the cementitious product 1 cracks the second material may be delivered to the crack by the branched channels 3. More than one second material may be used.

In some examples, the healing agent may be substantially formed from a resin material. In other examples, the healing agent may be substantially formed from a mineral material. In other examples, the healing agent may be substantially formed from biological material. In some examples, the healing agent may comprise a combination of the above different materials. The healing agent may be viscous. The healing agent may cure to form a solid or gel material.

For example, the healing agent may comprise one or more of: methylmethacrylate (MMA), cyanoacrylate (CA), polyurethane (PU) (the aforementioned being example resinous materials), sodium silicate (SS), Colloidal silicate (CS) (the aforementioned being example non-resinous materials), and bacteria (the aforementioned being an example biological material) for example.

The second material may be introduced to the branched channel 3 after a crack has formed in the cementitious product. Alternatively, the second material may be present in the branched channel prior to cracking. In the latter case, the second material may immediately enter the crack from the branched channel after formation of the crack.

The walls of the branched channels 3 may be formed from a polymer material such as Polylactic acid (PLA) or Acrylonitrile butadiene styrene (ABS), for example. Alternatively, the walls of the branched channels 3 may be formed from glass or ceramic material, for example. The walls of the branched channels may be configured to rupture when the cementitious product cracks, at the location of the crack. Accordingly, the branched channel 3 may open into the crack to allow the second material to enter the crack. The internal diameter of the branched channels 3 may be dependent on the second material so as to provide desired flow characteristics. In most examples, this may be at least 1 mm, preferably at least 2 mm. The wall thickness of the branched channels 3 may be less than 2 mm, less than 1 mm, or less than 0.5 mm. However, the precise thickness depends on the wall material, for example, among other things. If the wall is too thick it may not rupture as desired.

As shown, the branched channels 3 comprise a plurality of interconnected channel elements 30. The plurality of interconnected channel elements 30 comprise at least one diverging portion 31 at which a plurality of paths diverge from a common path, and/or at least one converging portion 32 at which a plurality of paths converge to a common path. The branched channels 3 may comprise at least two diverging portions 31 and/or at least two converging portions 32, for example.

Whether a portion is a diverging portion 31 or a converging portion 32 may be defined by reference to a nominal direction of flow through the branched channel 3. For example, the nominal direction of flow in FIG. 1 is in the right to left direction. Therefore, the branched channel 3 is nominally configured to flow the second material from a primary input 33 to a primary output 34, as shown in FIG. 1. It should be understood that this is a nominal reference direction only, the branched channel 3 itself may in fact be configured to permit flow of the second material in both directions. In other words, diverging portions 31 and converging portions 32 may be reversed.

As shown in FIG. 1, the branched channel 3 may be connected to one or more delivery channels 4. The delivery channels 4 may be configured to provide a channel from the branched channel 3 embedded with the substrate 2 to outside the substrate 2. The delivery channel 4 may be configured to provide a conduit for the delivery of the second material to the branched channel 3 from outside the cementitious product 1.

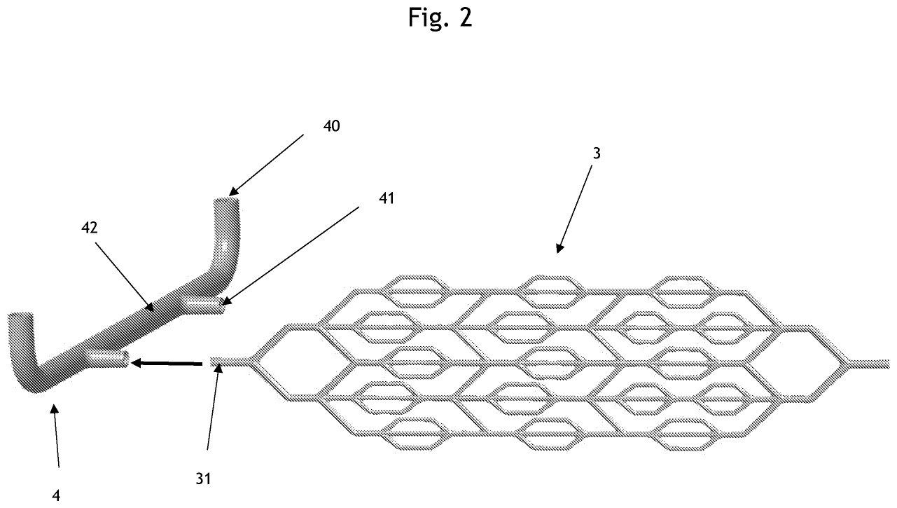

As shown in FIG. 2, the delivery channel 4 may comprise one or more delivery channel inlets 40 configured to be accessible from outside of the cementitious product 1. As shown in FIG. 2, the delivery channel 4 may comprise one or more delivery channel outlets 41 configured to be connected to the branched channel 3, and embedded within the substrate 2. As shown in FIG. 2, multiple inlets 40 and outlets 41 may be interconnected by a connecting portion 42 of the delivery channel 4.

As shown in the example in FIGS. 1 and 2, the inlets 41 and outlets 42 may be arranged at substantially 90 degrees to each other. As shown, the outlets 41 may be substantially parallel to an extension direction of the branched channel 3. As shown, the inlets 40 may be substantially perpendicular to an extension direction of the branched channel 3. In the example shown, the inlets 40 open at a top surface of the slab shaped cementitious product 3. In other examples, the delivery channel 4 may have an alternative configuration that is suited for a different cementitious product.

The second material may be pumped through the branched channel 3 via the delivery channels 4. In one example, the second material may be circulated around the branched channel 3, e.g. the second material entering the branched channel 3, passing through the branched channel 3, leaving the branched channel 3, and then re-entering the branched channel 3 again, in a circulatory fashion.

In an alternative example, the second material can be used to fill the branched channel 3, by passing through the branched channel 3, and remaining in the branched channel 3. In an alternative example, the branched channel 3 may be pre-filled with the second material, which is then encapsulated for later release into the product.

The channel elements 30 may be repeatable units that are interconnected to form the branched channel 3. Each channel element 30 may be one of a finite number of different types of channel element 3. For example, specific channel elements 30 may be selected from the different types of channel element 30 and arranged together to form a branched channel 30 having a desired shape. Some types of channel elements 30 may be reversible, e.g. such that diverging portions 31 of the channel element 30 when located at one position in the branched channel 3 may be converging portions 32 when located at another position.

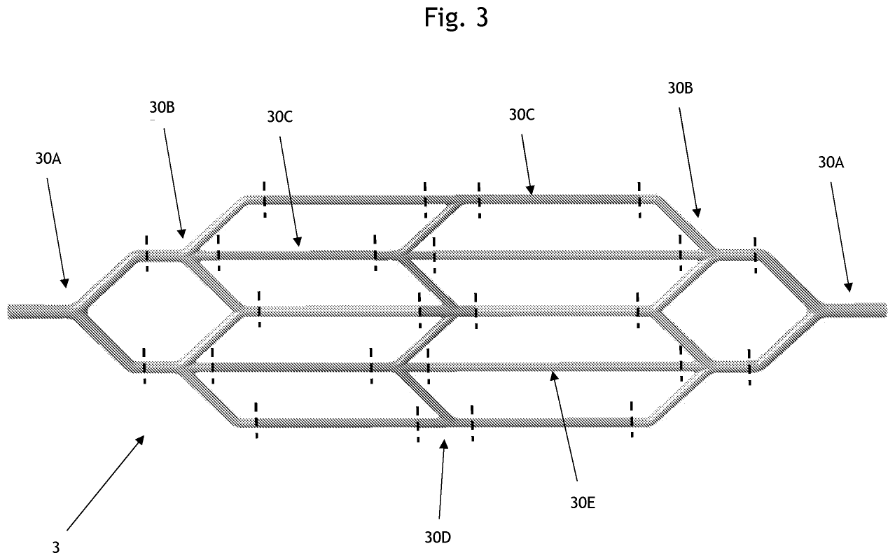

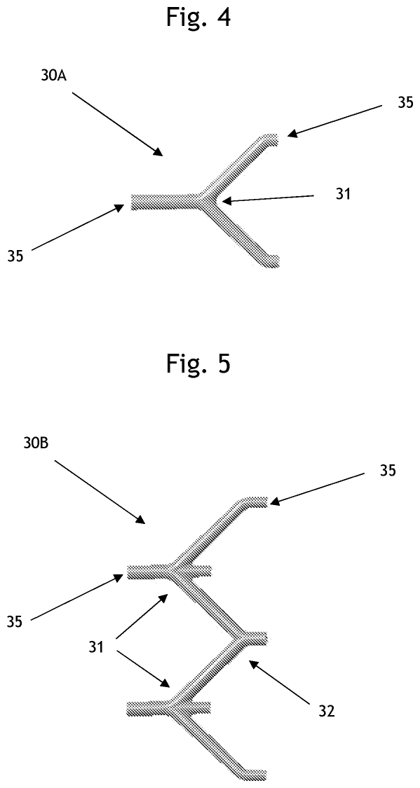

FIG. 3 shows an example branched channel 3. As shown the branched channel 3 comprises a plurality of interconnected channel elements 30 of different types 30A to 30E. The different channel elements 30 are denoted by different colours/shading and the interface between them is denoted by the dashed lines in FIG. 3. The different types of channel element 30 used in the branched channel 3 of FIG. 3 are shown in FIGS. 4 to 7.

As shown in FIGS. 4 to 7, each channel element 30 may comprise one or more input/output portions 35. The input/output portions 35 are arranged at the ends of paths formed by the channel elements 30. The input/output portions 35 are configured to be connected to input/output portions of another channel element to form the branched channel 30. In other words, the channel elements 30 are configured to be connected to each other, via the input/output portions 35. The input/output portions 35 allow the second material to flow from one channel element 30 to another. The interface between input/output portions 35 of interconnect channel elements are shown by the dashed lines in FIG. 3.

As shown in FIG. 3, the branched channel 3 may comprise at least one branching channel element 30A, 30B comprising m input/output portions connected to n further input/output portions, where m>0 and m<n. Using the nominal reference flow direction used to define the diverging portions 31 and converging portions 32, a branching channel element 30A, 30B may have m input portions than diverge to a greater number n of output portions, and/or n input portions that converge to a smaller number n output portions. The branching channel element 30A, 30B may have a net effect to expand (diverge) or contract (converge) the branched channel 3.

FIG. 4 shows a first example of a branching channel element 30A. As shown in FIG. 3, the branching channel element 30A may be used at one end of the branched channel 3 to expand the channel 3, e.g. on the left-hand side of FIG. 3, and may be used at another end of the branched channel 3 to contract the channel 3, e.g. on the right-hand side of FIG. 3.

As shown in FIG. 4, the branching channel element 30A may comprise only diverging portions or only converging portions. In other words, the branching channel element 30A may not include both diverging portions 31 and converging portions 32 in the same channel element 30. For example, as shown, branching channel element 30A may comprise only one diverging portion 31 or only one converging portion 32. The branching channel element 30A may be substantially Y-shaped for example, as shown.

FIG. 5 shows a second example of a branching channel element 30B. A shown in FIG. 3, the branching channel element 30B may be used at one end of the branched channel 3 to expand the channel 3, e.g. on the left-hand side of FIG. 3, and may be used at another end of the branched channel 3 to contract the channel 3, e.g. on the right hand side of FIG. 3.

As shown in FIG. 5, the branching channel element 30B may comprise both diverging and converging portions. For example, there may be more diverging paths than converging paths or vice versa. As shown, at least two diverging portions 31 may be connected at a converging portion 32, or at least two converging portions 32 may be connected at a diverging portion 31. The branching channel element 30B may comprise two diverging portions connected at one converging portion, for example. The branching channel element 30B may comprise at least two substantially Y-shaped portions that are connected to form a YY-shape for example (or with any number of adjacent Ys), as shown.

As shown in FIG. 3, the branched channel 3 may comprise at least one joining channel element 30C, 30D, 30E comprising p input/output paths connected to p further input/output portions, where p>0. Using the nominal reference flow direction used to define the diverging portions 31 and converging portions 32, a joining channel element 30C, 30D, 30E may preserve the same number of output portions as input portions, and vice versa. The joining channel element 30C, 30D, 30E may have a net effect to neither expand (diverge) nor contract (converge) the branched channel 3.

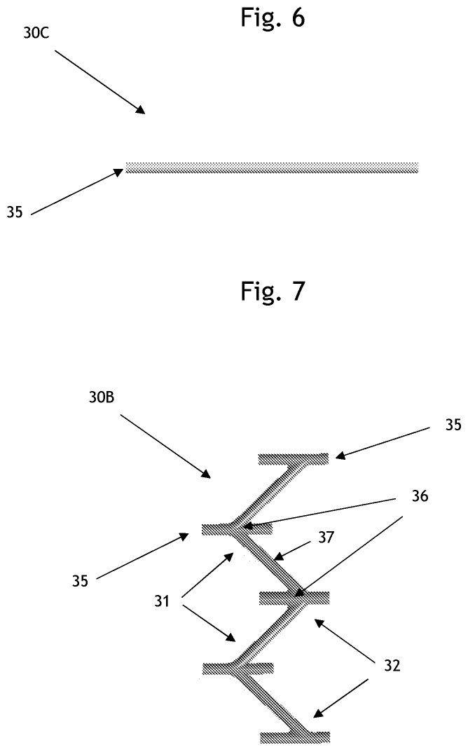

FIG. 6 shows a first example of a joining channel element that is a linear joining channel element 30C comprising only a single path between one input/output portion 35 and one further input/output portion 35. In other words, p equals 1. As shown, the single path may be a straight path. However, in other examples, the path may be curved, for example. The joining element 30E is also a linear joining element, but of a longer length to linear joining element 30C.

FIG. 7 shows a second example of a joining channel element that is a branching joining channel element 30D. The branching joining channel element 30D comprises at least one diverging portion 31 and at least one converging portion 32. As shown in FIG. 7, branching joining channel element 30D may comprise an unequal number of diverging portions and converging portions. As shown in FIG. 7, branching joining channel element 30D may comprise an equal number of diverging paths and converging paths.

As shown in FIG. 7, the branching joining channel element 30D may comprise a plurality of single paths 36 comprising one input/output portion 35 connected to one further input/output portion 35, said single paths 36 being connected to each other by at least one linking path 37. As shown, the single paths 36 may be substantially straight paths. As shown, the plurality of single paths 36 may be substantially parallel to each other. As shown, the linking paths 37 may extend at an acute angle from the single paths 36. As shown, the joining paths 37 may together form a zig-zag, but in modified versions may be aligned. As shown, each single path 36 may comprise one diverging portion 31 or converging portion 32 along its length.

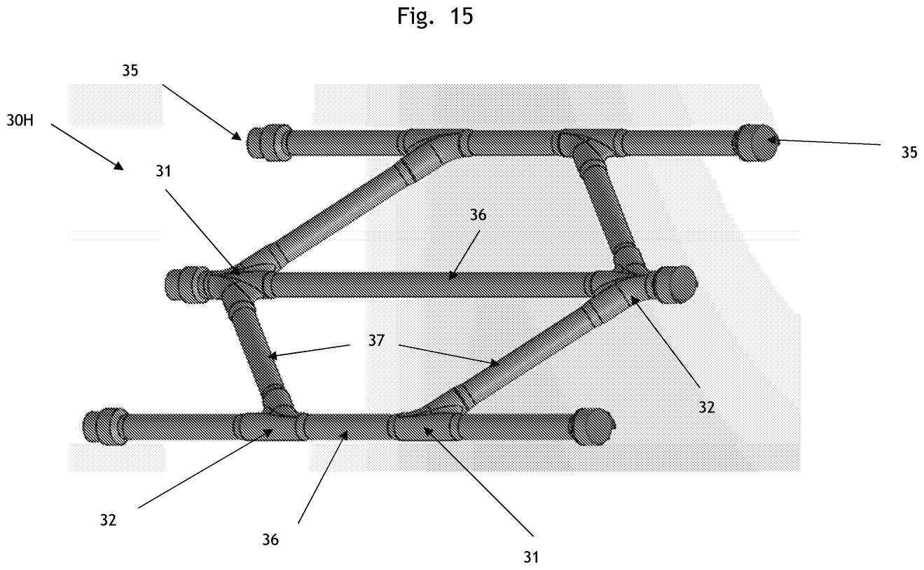

FIG. 15 shows an additional example branching joining channel element 30H, not shown in FIG. 3. The branching joining channel element 30H is similar to the branching joining channel element 30D, but each single path 36 may comprise more than one diverging portion 31 or converging portion 32 along its length, e.g. two. As shown, this may be one diverging portion 31 and one converging portion 32. Additionally, the single paths 36 may be aligned rather than zag-zagged, as shown.

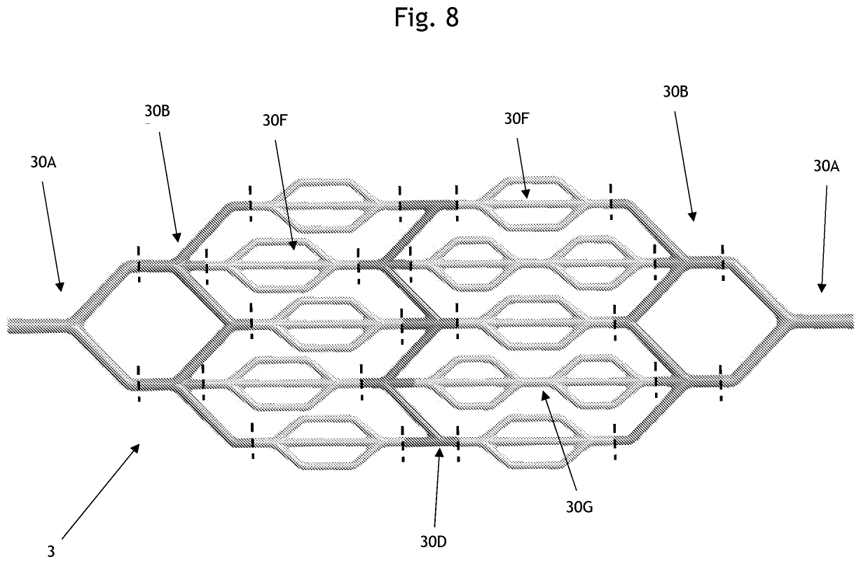

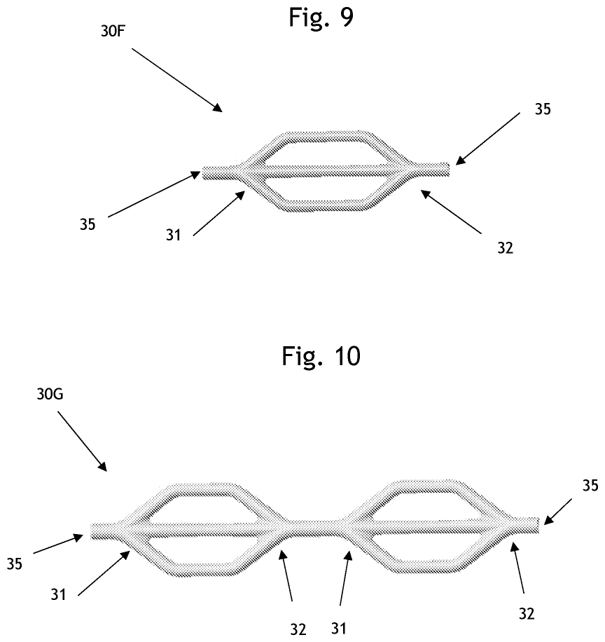

FIG. 8 shows a further example branched channel 3. As shown, the branched channel 3 comprises a plurality of interconnected channel elements 30 of different types 30A, 30B, 30D, 30F, 30G. The different channel elements 30 are denoted by different colours/shading and the interface between them is denoted by the dashed lines in FIG. 3. The further example branched channel 3 shown in FIG. 8 is substantially the same as the example branched channel 3 shown in FIG. 3, except that channel elements 30C and 30E have been replaced respectively by channel elements 30F and 30G. These channel elements are shown in FIGS. 9 and 10 respectively.

Channel elements 30F, 30G are further examples of joining channel elements. These joining channel elements 30F, 30G comprise p input/output paths connected to p further input/output portions, where p>0. These joining channel elements 30F, 30G may preserve the same number of output portions as input portions, and vice versa. These joining channel elements 30F, 30G may have a net effect to neither expand (diverge) nor contract (converge) the branched channel 3.

Each of the example joining channel elements 30F, 30G shown in FIGS. 9 and 10 is a branching joining channel element comprising at least one diverging portion 31 and at least one converging portion 32. As shown, these example branching joining channel elements 30F, 30G may comprise the same number of converging portions 31 as diverging portions 32. As shown, the branching joining channel elements 30F, 30G may comprise an equal number of diverging paths as converging paths.

A shown, each of the example joining channel elements 30F, 30G shown in FIGS. 9 and 10 may comprise at least one branching cell comprising one diverging portion 31 and one converging portion 32 having the same number of paths, said paths being respectively directly connected to each other.

As shown, the example branching joining channel element 30F shown in FIG. 9 may comprise a single branching cell. A shown, the example branching joining channel element 30F shown in FIG. 9 may comprise multiple, e.g. two, branching cells arranged in series.

The branching cells of the branching joining channel elements 30F, 30G increase the density of channels within the branched channel 3. This is illustrated clearly by the comparison between the branched channels 3 shown in FIGS. 3 and 8.

As shown in the Figures, each of the different types of channel elements 30 may have common features. These common features may improve their compatibility and interconnectability with each other as the building blocks of the branched channel 3.

For example, diverging portions 31 and converging portions 32 in within the same channel element 30 and/or in different channel elements 30 may diverge or converge at the same angle. The angle may be less than 90 degrees, e.g. around 75 degrees.

As shown in the Figures, each diverging or converging path may diverge from or converge to a common path symmetrically. For example, each diverging path may diverge at an angle less than 45 degrees from the common path, e.g. around 37 or 38 degrees. The common path may be a straight path. In some cases, the common path may continue beyond the diverging portion 31 or converging portion 32 (e.g. as shown in FIGS. 5, 7, 9, and 10). In other examples, paths diverging from a common path may diverge asymmetrically. The internal diameter of the diverging paths may be the same, or may be different. Different internal diameters may be used to achieve desired flow characteristics.

As shown, each input/output portion 35 may be substantially straight. As shown, each input/output portion 35 may be substantially parallel with each other. The distance between adjacent parallel input/output portions 35, in a direction orthogonal to the longitudinal direction of the branched channel 3, may be standardised within and between different channel elements 30. For example, the distances may be either X or 2X, where X is any desired length.

As shown, each diverging portion 31 may comprise two diverging paths, extending in opposing directions from the common path. In some examples, the common path may extend beyond the diverging portion 31 such that the common path becomes three paths (e.g. as shown in FIGS. 5, 7, 9, and 10). In some examples, the common path may stop at the diverging portion 31 such that the common path becomes two paths (e.g. as shown in FIG. 4).

As shown, each converging portion 33 may comprise two converging paths, extending in opposing directions towards the common path. In some examples, the common path may also extend towards the diverging portion 32 such that three paths become one common path (e.g. as shown in FIGS. 5, 7, 9, and 10). In some examples, the common path may start at the diverging portion 31 such that two paths become one common path (e.g. as shown in FIG. 4).

As shown, paths between adjacent diverging portions 31 and/or converging portions 32, or between a diverging portion 31 or a converging portion 32 and an adjacent input/output portion 35, may be substantially straight. As shown, paths between diverging portions 31 and/or converging portions 32, or between a diverging portion 31 or a converging portions 32 and an adjacent input/output portion 35, may be substantially parallel.

By combining the channel elements 30 described above, a branched channel 3 can be provided that has the desired characteristics for use with a particular cementitious product. For example, the overall transverse size of the branched channel 2 (or expansion) may be at least partly determined by the number and type of branching channel elements used. For example, the density of paths within the branched channel 3 may be at least partly determined by the types of joining channel element used.

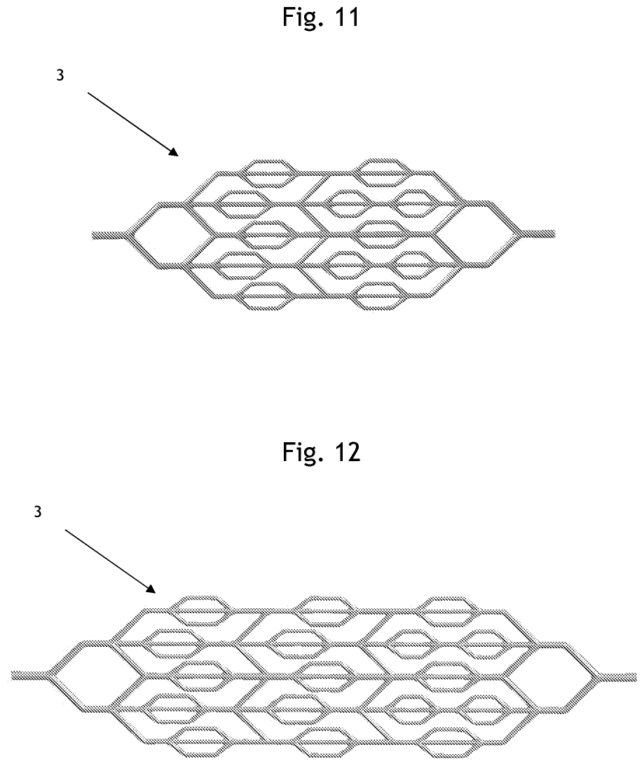

For example, the overall longitudinal size of the branched channel 2 (or expansion) may be at least partly determined by the number and type of branching channel elements used. FIGS. 11 and 12 show how a branched channel 3 can be expanded in the longitudinal direction by inserting additional joining channel elements. For example, FIG. 12 has one additional branching joining channel element 30C of a first type and five additional branching joining channel element 30F of a second type.

As shown in the examples in the Figures the channel elements 30 may extend substantially in two orthogonal directions (the width of the channel paths being substantially smaller and therefore not considered as a third orthogonal direction of extension), e.g. may be substantially two dimensional. As shown, the branched channel 3 may extend substantially in two orthogonal directions. However, two-dimensional channel elements 3 may be arranged to form a branched channel 3 that extends substantially in three orthogonal directions, e.g. that may be substantially three-dimensional.

In other examples, not shown, the channel elements 30 may extend substantially in three orthogonal directions, e.g. may be substantially three-dimensional. Accordingly, the branched channel 3 may extend substantially in three orthogonal directions, e.g. may be substantially three-dimensional. In some examples, the two-dimensional and three-dimensional channel elements 30 may be combined in the same branched channel 3.

The channel elements 30 may be integrally formed with one another to be interconnected. The branched channel 3 may be formed by additive manufacturing, for example, e.g. 3D printing. Alternatively, the branched channel 3 may be formed by moulding, such as injection moulding. The moulds may be formed by additive or subtractive manufacturing methods, for example.

As in the examples shown, the channel elements 30 may be formed separately and then interconnected during an assembly of the branched channel 3. The separately formed channel elements 30 may be formed by additive manufacturing, for example, e.g. 3D printing. Alternatively, the separately formed channel elements 30 may be formed by moulding, such as injection moulding. The moulds may be formed by additive or subtractive manufacturing methods, for example.

The interconnection may be implemented by a connection mechanism. The connection mechanism may be integrated with the channel elements 30, for example. For example, the channel elements 30 may comprise male and/or female parts configured to engage with corresponding male and/or female parts of another channel element 30. Female parts may be relatively narrow, and male parts may be relatively wide, so as to engage with each other. The male and female parts may be bonded together, for example by heat welding, solvent welding, or the use of an adhesive. Heat welding may be performed using a heat gun to partially melt the connecting parts at their interface. Solvent welding may be performed by applying a solvent to partially dissolve the connecting parts at their interface.

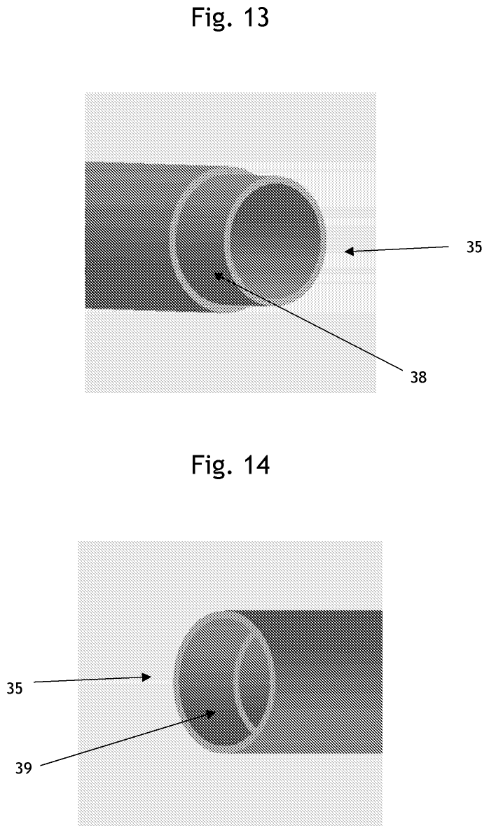

FIGS. 13 and 14 show example male and female connecting parts 38, 39 integrally formed at input/output portions 35. As shown, the male connecting part 38 may be formed by narrowing an external wall portion. As shown, the wall thickness may be substantially halved in this portion. As shown, the female connecting part 39 may be formed by narrowing an internal wall portion. As shown, the wall thickness may be substantially halved in this portion. As shown, there may be a step change in the wall thickness. Alternatively, the wall thickness may be tapered gradually.

In some examples, the connection mechanism may include a separate connector configured to connect two adjacent channel elements 30, for example.

Regardless of the types of channel elements provided (such as those described above, or others), providing a finite number of different types of channel elements 30 constrains and therefore simplifies the design process for a branched channel 3. This may reduce the burden on implementing a branched channel 2 into a cementitious product 1. For example, the combination of branching channel elements and joining channel elements generally enables expansion of the branched channel in 1 two or three orthogonal directions to extend over a specific cementitious product with a specific shape. For example, selecting from different types of branching channel elements and joining channel elements may provide some control over the density of channel paths at various locations in the cementitious product, thus improving the coverage of the branched channel 3.

Branched channels 3 may be designed by a computer implemented design process. For example, the computer may optimise the design of a branched channel 3 based on required parameters that may be provided to the computer by a user. For example, a first parameter may be the size and shape of the cementitious product for which the branched channel 3 is to be used. For example, a second parameter may be a desired path density. This may vary depending on location within the cementitious product, for example. The computer may build a virtual model of the branched channel 3 from virtual models of the available different types of channel elements 30. The computer may perform an iterative process wherein an initial design is modified until the design is optimised for the specified parameters.

Based on the design, the computer may additionally provide instructions to a manufacturing apparatus to manufacture the branched channel 3. For example, the computer may provide instructions to form the branched channel 3 or required channel elements 30 by additive manufacturing, e.g. 3D printing, for example. Alternatively, the computer may provide instructions to form a mould for the branched channel 3 or required channel elements 30 by additive or subtractive manufacturing methods, for example.

It should be understood that variations of the above described examples are possible without departing from the spirit or scope of the disclosure.

1. A cementitious product comprising:
a substrate formed from a cementitious material; and
at least one branched channel embedded within the substrate configured to provide a conduit for a second material to flow through the substrate;
wherein the at least one branched channel comprises a plurality of interconnected channel elements, the plurality of interconnected channel elements comprising at least one diverging portion at which a plurality of paths diverge from a common path, and/or at least one converging portion at which a plurality of paths converge to a common path.

2. The cementitious product of claim 1, wherein the channel elements are formed separately and configured to be connected during assembly of the branched channel, and optionally wherein the channel elements are repeatable units selected from a finite number of different types of channel elements, formed separately and configured to be connected via input/output portions during assembly of the branched channel.

3. (canceled)

4. The cementitious product of claim 2, wherein the branched channel comprises at least one of each of the following types of channel element:
a branching channel element comprising m input/output portions connected to n further input/output portions, where m>0 and m<n, and only one diverging portion or only one converging portion;
a branching channel element comprising m input/output portions connected to n further input/output portions, where m>1 and m<n, and at least two diverging portions are connected at a converging portion or at least two converging portions are connected at a diverging portion;
a branched joining channel element comprising p input/output portion connected to p further input/output portion, where p>0, and at least one branching cell comprising one diverging portion and one converging portion having the same number of paths, said paths being respectively directly connected to each other;
a branched joining channel element comprising p input/output portion connected to p further input/output portion, where p>1, and comprising p single paths comprising one input/output portion connected to one further input/output portion, said single paths connected to each other by at least one linking path.

5. The cementitious product of claim 4, wherein the branched channel comprises at least one type of channel element that is a branched joining channel element comprising one input/output portion connected to one further input/output portion, and multiple branching cells arranged in series, each branching cell comprising one diverging portion and one converging portion having the same number of paths, said paths being respectively directly connected to each other.

6. The cementitious product of claim 1, wherein the plurality of channel elements comprise at least one branching channel element comprising m input/output portions connected to n further input/output portions, where m>0 and m<n, the plurality of interconnected channel elements being configured to be connected via the input/output portions.

7. The cementitious product of claim 6, wherein the branching channel element comprises only diverging portions or only converging portions, optionally wherein the branching channel element comprises only one diverging portion or only one converging portion.

8. (canceled)

9. The cementitious product of claim 6, wherein the branching channel element comprises both diverging and converging portions.

10. The cementitious product of claim 6, wherein at least two diverging portions are connected at a converging portion or at least two converging portions are connected at a diverging portion.

11. The cementitious product of claim 1, wherein the plurality of channel elements comprise at least one joining channel element comprising p input/output paths connected to p further input/output portions, where p>0, the plurality of interconnected channel elements being configured to be connected via the input/output portions.

12. (canceled)

13. The cementitious product of claim 11, wherein at least one joining channel element is a branching joining channel element comprising at least one diverging portion and at least one converging portion.

14. The cementitious product of claim 13, wherein the branching joining channel element comprises the same number of converging portions as diverging portions.

15. The cementitious product of claim 13, wherein the branching joining channel element comprises at least one branching cell comprising one diverging portion and one converging portion having the same number of paths, said paths being respectively directly connected to each other.

16. The cementitious product of claim 15, wherein the branching joining channel element comprises multiple branching cells arranged in series.

17. The cementitious product of claim 16, wherein the branching joining channel element comprises an unequal number of diverging portions and converging portions.

18. The cementitious product of claim 13, wherein the branching joining channel element comprises a plurality of single paths comprising one input/output portion connected to one further input/output portion, said single paths connected to each other by at least one linking path.

19. The cementitious product of claim 1, wherein the plurality of interconnected channel elements extend substantially in two orthogonal directions.

20. The cementitious product of claim 1 wherein the plurality of interconnected channel elements extend substantially in three orthogonal directions.

21. The cementitious product of claim 1, wherein the channel elements are formed from a polymer material, optionally wherein the channel elements are formed from a polylactic acid (PLA).

22. (canceled)

23. The cementitious product of claim 1, comprising the second material within the at least one branched channel.

24. The cementitious product of claim 1, wherein the second material comprises gap filling material configured to fill gaps in the cementitious product.

25-39. (canceled)
